(19) United States
(12) Patent Application Publication
(10) Pub. No.: US 2026/0088643 A1
(43) Pub. Date: Mar. 26, 2026

(54) CHARGING DEVICE

(71) Applicant: Anker Innovations Technology Co., Ltd., CHANGSHA (CN)

(72) Inventors: Xiaoshu ZHANG, SHENZHEN (CN); Zhichao XIONG, SHENZHEN (CN)

(73) Assignee: Anker Innovations Technology Co., Ltd., CHANGSHA (CN)

(21) Appl. No.: 19/315,884

(22) Filed: Sep. 2, 2025

(30) Foreign Application Priority Data
Sep. 20, 2024 (CN) 202411320234.4

(51) Int. Cl. H02J 7/00

(52) U.S. Cl. CPC H02J 7/80; H02J 7/70; H02J 7/50; H02J 2207/30

(57) ABSTRACT

A charging device includes a housing, a plug assembly, a display assembly, and an interface assembly. The housing includes a first surface, a second surface, and a third surface. The first surface and the second surface are disposed opposite to each other, and the third surface is adjacent to the first surface and the second surface, respectively. The display assembly is disposed on the first surface and configured to display charging information of the charging device. The plug assembly is disposed on the second surface. When the plug assembly is inserted into the socket, the display assembly faces a side away from the socket. The interface assembly is disposed on the third surface.

### CROSS REFERENCE TO RELATED APPLICATIONS

The present application claims priority to Chinese Patent Application No. 202411320234.4, entitled “A CHARGING DEVICE”, filed on Sep. 20, 2024, which is herein incorporated by reference in its entirety.

### TECHNICAL FIELD

The present disclosure relates to the technical field of charging, and in particular to a charging device.

### BACKGROUND

With the popularity of electronic devices, users' demand for charging devices of the electronic devices is increasing day by day. The electronic devices are charged through the charging devices. Currently, the charging devices only provide basic charging functions, but do not provide interaction functions for the user. As a result, the users cannot obtain detailed information about the charging process of the electronic devices through charging devices, such as charging power or remaining charging time. This lack of information causes the users to experience unnecessary anxiety during the charging process, known as charging anxiety, which negatively affects the user experience.

### SUMMARY OF THE DISCLOSURE

The present disclosure provides a charging device including a housing, a display assembly, a plug assembly, and an interface assembly. The housing includes a first surface, a second surface, and a third surface. The first surface and the second surface are disposed opposite to each other, and the third surface is adjacent to the first surface and the second surface, respectively. The display assembly is disposed on the first surface and configured for displaying charging information of the charging device. The plug assembly is disposed on the second surface and configured to be inserted into an external socket to receive external power input. When the plug assembly is inserted into the socket, the display assembly faces a side away from the socket. The interface assembly is disposed on the third surface and configured to be connected to a to-be-charged device, so that the to-be-charged device is charged.

In some embodiments, the plug assembly includes plugs and a plug panel, the plugs are disposed on the plug panel; and when the plugs are inserted into the socket, the plug panel is in direct contact with the socket.

In some embodiments, the charging device further includes a motherboard assembly disposed in an accommodating space of the housing. The motherboard assembly is connected to the plug assembly, the display assembly, and the interface assembly, respectively.

In some embodiments, the motherboard assembly includes an output circuit board, a display circuit board, and a first power circuit board. The output circuit board is disposed close to the interface assembly, the display circuit board is disposed close to the display assembly, and the first power circuit board is disposed on a side of the housing. The output circuit board and the display circuit board are configured to intersect with the first power circuit board, respectively.

In some embodiments, the output circuit board is electrically connected to the interface assembly, the display circuit board, and the first power circuit board, respectively. The display circuit board is electrically connected to the display assembly.

In some embodiments, the motherboard assembly further includes a second power circuit board, a filter circuit board, and an input circuit board. The second power circuit board is configured to intersect with the output circuit board and the first power circuit board, respectively. The filter circuit board is spaced apart from the second power circuit board and disposed on a side of the second power circuit board away from the display circuit board. The input circuit board is disposed close to the plug assembly and spaced apart from the first power circuit board, and the input circuit board is configured to intersect with the filter circuit board.

In some embodiments, the input circuit board is electrically connected to the plug assembly and the filter circuit board, respectively. The second power circuit board is electrically connected to the first power circuit board.

In some embodiments, the display assembly includes a display screen and a display lens, the display lens is disposed on the housing, and the display screen is disposed on a side of the display circuit board away from the input circuit board and configured for displaying the charging information.

In some embodiments, the display assembly further includes an operation assembly, the operation assembly is disposed on a side of the display lens close to the interface assembly, and the operation assembly is configured for receiving an operation instruction to operate on the display screen.

In some embodiments, the interface assembly includes at least one interface and a decorative member, the at least one interface is disposed on the output circuit board, the decorative member is disposed on the housing, and the decorative member defines at least one through hole, so that one of the at least one interface is exposed through a corresponding one of the at least one through hole.

In some embodiments, the charging device further includes at least one cable, the at least one cable is electrically connected to the interface assembly, and the charging device is configured to facilitate charging of the to-be-charged device connected to the interface assembly through the at least one cable.

The present disclosure provides a charging device including a housing, a display assembly, a plug assembly, and an interface assembly. The display assembly is disposed on the housing and configured for displaying charging information of the charging device. The plug assembly is disposed on the housing and opposite to the display assembly, and the plug assembly is configured to be inserted into an external socket. The interface assembly is disposed on the housing, the interface assembly is disposed between the display assembly and the plug assembly, and the interface assembly is configured to be connected to a to-be-charged device.

### BRIEF DESCRIPTION OF THE DRAWINGS

In order to more clearly describe the technical solutions in some embodiments of the present disclosure, hereinafter, the accompanying drawings that are used in the description of some embodiments will be briefly described. Obviously, the accompanying drawings in the description below merely show some embodiments of the present disclosure. For those of ordinary skill in the art, other accompanying drawings may be obtained based on these accompanying drawings without any creative efforts.

FIG. 1 is a structural schematic view of a charging device in some embodiments of the present disclosure.

FIG. 2 is an exploded schematic view of the charging device of FIG. 1.

FIG. 3 is a structural schematic view illustrating the charging device of FIG. 1 inserted into a socket.

FIG. 4 is a three-dimensional structural schematic view of a motherboard assembly of FIG. 2 in some embodiments of the present disclosure.

FIG. 5 is an exploded schematic view of the motherboard assembly of FIG. 4 in some embodiments of the present disclosure.

FIG. 6 is a structural schematic view illustrating connections of various circuit boards of the motherboard assembly of FIG. 5 in some embodiments of the present disclosure.

FIG. 7 is a structural block view illustrating the charging device of FIG. 1 and external to-be-charged devices in some embodiments of the present disclosure.

### DETAILED DESCRIPTION

Embodiments of technical solutions of the present disclosure may be described in detail by combining the accompanying drawings. The following embodiments are only used to illustrate the technical solutions of the present disclosure more clearly. Therefore, the following embodiments are only exemplary and cannot be used to limit the protection scope of the present disclosure.

Unless otherwise defined, all technical and scientific terms used in the present disclosure have the same meanings as commonly understood by those skilled in the art belonging to the present disclosure. The terms used in the present disclosure are only for the purpose of describing the specific embodiments, and are not intended to limit the present disclosure. The terms “including” and “comprising” as well as any variations thereof in specification, claims, and above description of the drawings of the present disclosure are intended to cover non-exclusive inclusions.

In the description of the embodiments of the present disclosure, technical terms, such as “first”, “second” and the like, are only used to distinguish different objects, and cannot be understood as indicating or implying relative importance or implicitly indicating quantity, specific order, or primary secondary relationship of the indicated technical features.

The reference to “embodiment” in the present disclosure means that, specific features, structures, or characteristics described in conjunction with some embodiments may be included in at least one embodiment of the present disclosure. The phrase appearing in various positions in the specification does not necessarily refer to the same embodiment, nor is it an independent or alternative embodiment that is mutually exclusive with other embodiments. Those of ordinary skill in the art explicitly and implicitly understand that the embodiments described in the present disclosure can be combined with other embodiments.

In the description of the embodiments of the present disclosure, the term “multiple” or “plurality” refers to two or more (including two). Similarly, “multiple groups” or “plurality of groups” refers to two groups or more groups (including two groups), and “multiple pieces” or “plurality of pieces” refers to two pieces or more pieces (including two pieces).

In the description of the embodiments of the present disclosure, the directions or positional relationships indicated by the terms, “center”, “longitudinal”, “transverse”, “length”, “width”, “thickness”, “up”, “down”, “front”, “back”, “left”, “right”, “vertical”, “horizontal”, “top”, “bottom”, “inside”, “outside”, “clockwise”, “counterclockwise”, “axial”, “radial”, “circumferential”, etc. are based on the methods or positional relationships shown in the accompanying drawings. It is only intended to facilitate the description of the embodiments of the present disclosure and simplify the description, but does not indicate or imply that the device or the element referred to must have a specific orientation, be constructed and operated in a specific orientation. Therefore, they cannot be understood as limiting the embodiments of the present disclosure.

In the description of the embodiments of the present disclosure, unless otherwise expressly specified and limited, the terms “installation”, “connection”, “fixation” should be broadly understood. For example, it may be a fixed connection, a detachable connection, or an integrated connection; it may be a mechanical connection or an electrical connection; it may be a direct connection or an indirect connection through an intermediate medium; it may be internal communication of two elements or an interaction relationship between two elements. For those of ordinary skill in the art, the specific meanings of the above terms in the embodiments of the present disclosure may be understood according to the specific situation.

The present disclosure provides a charging device, so as to solve a problem of charging anxiety.

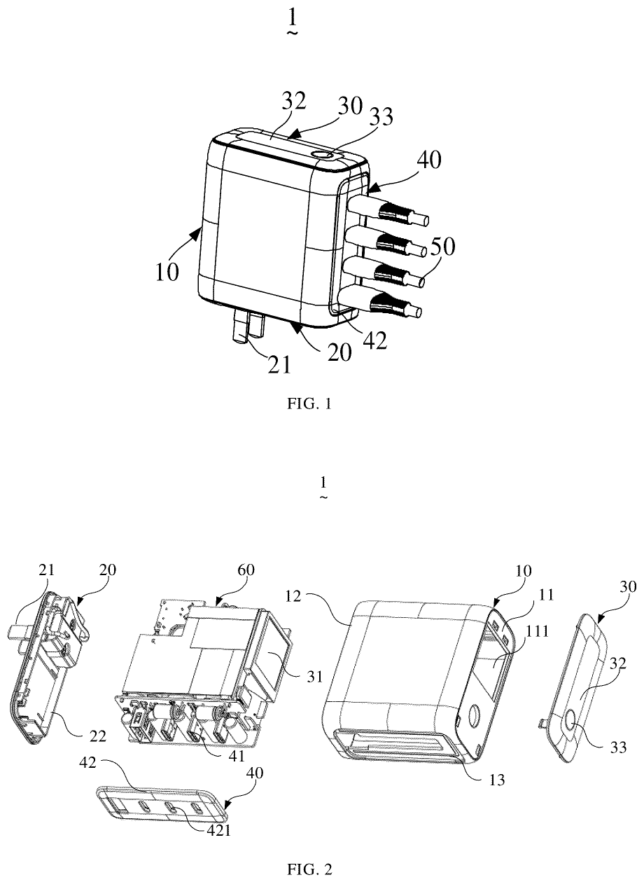

Referring to FIGS. 1, 2, and 7, FIG. 1 is a structural schematic view of a charging device in some embodiments of the present disclosure, FIG. 2 is an exploded schematic view of the charging device of FIG. 1, and FIG. 7 is a structural block view illustrating the charging device of FIG. 1 and external to-be-charged devices in some embodiments of the present disclosure. In some embodiments, a charging device 1 is configured to facilitate charging of an external to-be-charged device 2. The external to-be-charged device 2 may include but is not limited to a mobile phone, a tablet, a laptop, etc. The charging device 1 in some embodiments does not belong to a charger or a charging gun of an electric vehicle and cannot be configured to charge the electric vehicle.

In some embodiments, the charging device 1 includes a housing 10, a plug assembly 20, a display assembly 30, and an interface assembly 40.

The housing 10 includes a first surface 11, a second surface 12, and a third surface 13. The first surface 11 and the second surface 12 are disposed opposite to each other. The third surface 13 is adjacent to the first surface 11 and the second surface 12, respectively. The first surface 11 and the second surface 12 are disposed opposite to each other, which means that the first surface 11 is directly opposite the second surface 12 or the first surface 11 faces the second surface 12 directly. The third surface 13 is adjacent to the first surface 11 and the second surface 12 respectively, which means that the third surface 13 is located between the first surface 11 and the second surface 12.

The display assembly 30 is disposed on the first surface 11, and configured to display charging information of the charging device 1. That is, the display assembly 30 is installed on the first surface 11, and the charging information of the charging device 1 may include but is not limited to a parameter such as charging power, charging current, or charging voltage of the charging device 1. Therefore, a user can directly obtain the parameter such as the charging power, the charging current, or the charging voltage of the charging device 1 through the display assembly 30. The charging power of the charging device 1 refers to the power supplied by the charging device 1 to the to-be-charged device 2 during charging. The charging current of the charging device 1 refers to the current supplied by the charging device 1 to the to-be-charged device 2 during charging. The charging voltage of the charging device 1 refers to the voltage supplied by the charging device 1 to the to-be-charged device 2 during charging.

Compared with the charging device in related art that only provides a charging function, in some embodiments of the present disclosure, the charging device 1 includes the display assembly 30 that is disposed on the first surface 11 and configured to display the charging information of the charging device 1. By disposing the display assembly 30 on the first surface 11 of the housing 10, the user can obtain the charging information through the display assembly 30, which can effectively alleviate the user's charging anxiety and improve the user experience during charging.

The plug assembly 20 is disposed on the second surface 12, and configured to be inserted into an external socket to receive external power input. That is, the charging device 1 is inserted into the external socket through the plug assembly 20, so as to provide power to the charging device 1 through an external power source. When inserting the plug assembly 20 into the socket, the display assembly 30 faces a side away from the socket. In some embodiments, the plug assembly 20 may be installed on the second surface 12 of the housing 10 by a snap-fit method. The snap-fit method may be a snap-fit method in the related art and therefore not described in detail here.

The plug assembly 20 is disposed on the second surface 12 of the housing 10, and the display assembly 30 is disposed on the first surface 11 of the housing 10, that is, the plug assembly 20 is disposed directly opposite the display assembly 30. Therefore, when the plug assembly 20 is inserted into the socket, the display assembly 30 faces a side away from the socket, and in this case, the display assembly 30 faces the user.

In some embodiments, the plug assembly 20 is disposed on the second surface 12. When the plug assembly 20 is inserted into the socket, the display assembly 30 faces a side away from the socket, that is, the display assembly 30 faces the user. By the above methods, the user conveniently views the display assembly 30 to obtain the charging information, thereby improving the user experience during charging.

The interface assembly 40 is disposed on the third surface 13 and configured to be connected to the to-be-charged device 2, so that the to-be-charged device 2 is charged.

In some embodiments, the charging device 1 further includes a cable 50 located between the interface assembly 40 and the to-be-charged device 2, and the cable 50 is configured for connecting the interface assembly 40 and the to-be-charged device 2. The cable 50 may also be referred to as a data cable or a charging cable, etc.

In some embodiments, the interface assembly 40 is disposed on the third surface 13 and configured to be connected to the to-be-charged device 2, so that the to-be-charged device 2 is charged. The interface assembly 40 is located between the plug assembly 20 and the display assembly 30, so that the cable 50 between the to-be-charged device 2 and the interface assembly 40 is properly routed or has reasonable wiring.

In some embodiments, the housing 10 may include a middle frame assembly. The plug assembly 20, the display assembly 30, and the interface assembly 40 are respectively disposed on the middle frame assembly, so as to form the charging device 1. In some embodiments, the housing 10 may further include multiple detachable shells, and the multiple detachable shells are installed to form the housing 10. In some embodiments, the housing 10 may be configured as a one-piece structure, and the housing 10 may be integrally formed.

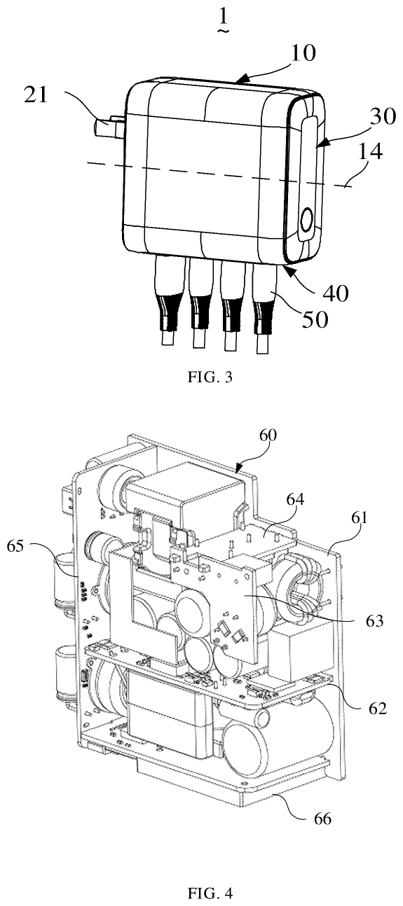

In some embodiments of the present disclosure, referring to FIGS. 1 to 3, FIG. 3 is a structural schematic view illustrating the charging device of FIG. 1 inserted into a socket. In some embodiments, the plug assembly 20 includes plugs 21 and a plug panel 22, the plug panel 22 is disposed on the housing 10, and the plugs 21 are disposed on the plug panel 22.

In some embodiments, the plug panel 22 is attached to the housing 10 through a snap-fit mechanism and then combined with the housing 10 using an ultrasonic technology. The ultrasonic technology includes but is not limited to ultrasonic plastic welding. Therefore, the plug panel 22 and the housing 10 are formed into a whole. In this case, the plug panel 22 is equivalent to the second surface 12 of the housing 10, which improves the aesthetic appeal of the charging device 1.

In some embodiments, the plugs 21 are disposed on a side of the plug panel 22 away from the interface assembly 40, that is, the plugs 21 do not overlap with a centerline 14 of the housing 10. The plugs 21 are located on a side of the centerline 14 away from the interface assembly 40.

In some embodiments, the plugs 21 may be fixed to the plug panel 22, that is, the plugs 21 cannot be rotatable relative to the plug panel 22. In some embodiments, the plugs 21 may be rotatable relative to the plug panel 22, the plug panel 22 defines grooves corresponding to the plugs 21, so that the plugs 21 are located in the grooves after rotating the plugs 21.

When the socket is disposed on a surface of an external wall and the plugs 21 are inserted into the socket located on the surface of the wall, due to the plugs 21 being disposed on the side of the plug panel 22 away from the interface assembly 40, a center of gravity of the charging device 1 is lower than the plugs 21. Under the gravity of the charging device 1, the plug panel 22 can be fully utilized to support the socket, effectively reducing the risk of the charging device 1 falling during use.

In some embodiments of the present disclosure, when plugs 21 are inserted into the socket, the plug panel 22 is in direct contact with the socket.

The socket is disposed on the surface of the external wall, the center of gravity of the charging device 1 is lower than the plugs 21, and the cable 50 connecting the interface assembly 40 and the to-be-charged device 2 is located below the plugs 21. Therefore, under the gravity of the charging device 1, the plug panel 22 is in direct contact with the socket, which can further reduce the risk of the charging device 1 falling during use.

In some embodiments of the present disclosure, as shown in FIG. 1, the socket is disposed on a horizontal plane. In some embodiments, the socket is disposed on a desktop. When the plugs 21 are inserted into the socket, the plug panel 22 is in direct contact with the socket, and the display assembly 30 faces a side away from the socket, that is, the display assembly 30 faces the user. It facilitates the user viewing the display assembly 30 to obtain the charging information, thereby improving the user's experience during charging.

In some embodiments, the cable 50 between the to-be-charged device 2 and the interface assembly 40 exits from or is routed out from a side surface (i.e. the third surface 13 of the housing 10) of the charging device 1, achieving a reasonable wiring of the cable 50 between the to-be-charged device 2 and the interface assembly 40.

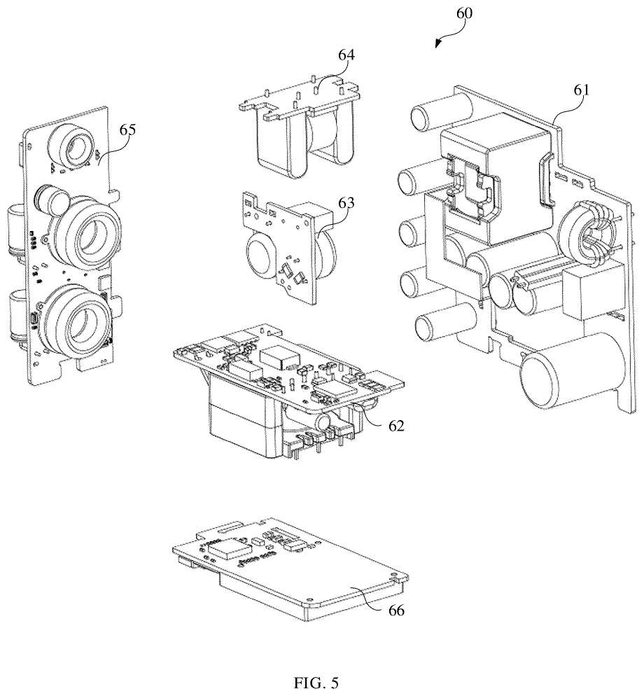

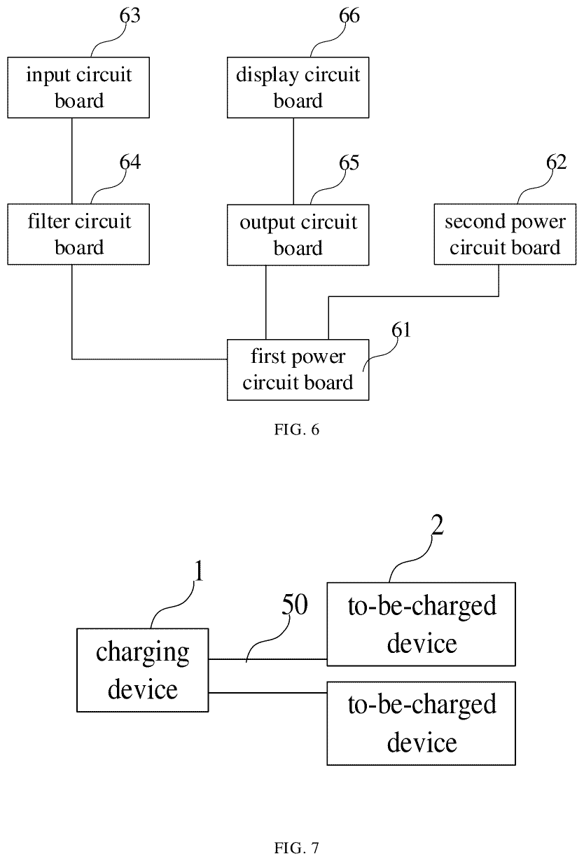

In some embodiments of the present disclosure, referring to FIGS. 1, 2, 4, 5, and 6, FIG. 4 is a three-dimensional structural schematic view of a motherboard assembly of FIG. 2 in some embodiments of the present disclosure, FIG. 5 is an exploded schematic view of the motherboard assembly of FIG. 4 in some embodiments of the present disclosure, and FIG. 6 is a structural schematic view illustrating connections of various circuit boards of the motherboard assembly of FIG. 5 in some embodiments of the present disclosure. In some embodiments, the charging device 1 further includes a motherboard assembly 60.

The housing 10 defines an accommodating space, and the motherboard assembly 60 is disposed in the accommodating space of the housing 10. The motherboard assembly 60 is connected to the plug assembly 20, the display assembly 30, and the interface assembly 40, respectively. That is, the plug assembly 20, the display assembly 30, and the interface assembly 40 are all electrically connected to the motherboard assembly 60.

In some embodiments, the motherboard assembly 60 is disposed in the accommodating space of the housing 10, and the motherboard assembly 60 is connected to the plug assembly 20, the display assembly 30, and the interface assembly 40, respectively. Therefore, the charging device 1 is designed to be compact and portable, making it suitable for multiple scenarios such as home, office, or travel, thereby improving the user experience during charging.

In some embodiments of the present disclosure, the motherboard assembly 60 includes a first power circuit board 61, an output circuit board 65, and a display circuit board 66.

The output circuit board 65 is disposed close to the interface assembly 40, that is, the output circuit board 65 is disposed inside the housing 10 and close to the interface assembly 40. By disposing the output circuit board 65 close to the interface assembly 40, it facilitates the electrically connection between the output circuit board 65 and the interface assembly 40.

The display circuit board 66 is disposed close to the display assembly 30, that is, the display circuit board 66 is disposed inside the housing 10 and close to the display assembly 30. By disposing the display circuit board 66 close to the display assembly 30, it facilitates the electrically connection between the display circuit board 66 and the display assembly 30.

The first power circuit board 61 is disposed on a side of the housing 10, a size of the first power circuit board 61 is greater than that of the output circuit board 65, and a size of the first power circuit board 61 is greater than that of the display circuit board 66. The first power circuit board 61 is laid flat inside the housing 10, so as to make reasonable use of the accommodating space of the housing 10.

The output circuit board 65 and the display circuit board 66 are configured to intersect with the first power circuit board 61, respectively. That is, the output circuit board 65 is configured to intersect with the first power circuit board 61, and the display circuit board 66 is configured to intersect with the first power circuit board 61. In some embodiments, the output circuit board 65 intersects with the first power circuit board 61, the output circuit board 65 intersects with the display circuit board 66, and the display circuit board 66 intersects with the first power circuit board 61.

The output circuit board 65 in configured to intersect with the first power circuit board 61, which means that the output circuit board 65 is electrically connected to the first power circuit board 61, and a predetermined angle (such as a first angle below) is defined between the output circuit board 65 and the first power circuit board 61. The intersection settings between other circuit boards are the same, and therefore are not be described in detail one by one in the present disclosure.

In some embodiments, the output circuit board 65 is disposed on a side of the first power circuit board 61 close to the interface assembly 40, the display circuit board 66 is disposed on a side of the first power circuit board 61 close to the display assembly 30, and the display circuit board 66 is disposed on the output circuit board 65. The first angle is defined between the output circuit board 65 and the first power circuit board 61, that is, the output circuit board 65 intersects with the first power circuit board 61. A second angle is defined between the display circuit board 66 and the first power circuit board 61, that is, the display circuit board 66 intersects with the first power circuit board 61. A third angle is defined between the display circuit board 66 and the output circuit board 65, that is, the display circuit board 66 intersects with the output circuit board 65. In some embodiments, the first angle, the second angle, and the third angle are all 90 degrees. By the above method, the output circuit board 65, the display circuit board 66, and the first power circuit board 61 together define the accommodating space of the housing 10.

In some embodiments, the output circuit board 65 is provided with a latching part, and the first power circuit board 61 defines a corresponding through-hole. The latching part of the output circuit board 65 is inserted into the through-hole of the first power circuit board 61, and the latching part of the output circuit board 65 and the first power circuit board 61 are soldered together by using solder, so that the output circuit board 65 is disposed on the first power circuit board 61. This design facilitates installation of the output circuit board 65 on the first power circuit board 61. In some embodiments, the output circuit board 65 may be disposed on the first power circuit board 61 through other means. The way in which the display circuit board 66 is disposed on the first power circuit board 61 is the same as the way in which the output circuit board 65 is disposed on the first power circuit board 61, and the way in which the display circuit board 66 is disposed on the output circuit board 65 is the same as the way in which the output circuit board 65 is disposed on the first power circuit board 61, which may not be repeated here.

The first power circuit board 61 may be a main power circuit board and configured to integrate multiple power modules of the charging device 1. The output circuit board 65 includes a DC-DC circuit that is configured for outputting multiple different output voltages. In some embodiments, the output circuit board 65 may further include a temperature sensor, and the temperature sensor is configured to control temperature when the to-be-charged device 2 is charged by using the charging device 1. The display circuit board 66 is configured to receive the charging information and display the charging information through the display assembly 30.

In some embodiments, the output circuit board 65 is electrically connected to the interface assembly 40, the display circuit board 66, and the first power circuit board 61, respectively. The display circuit board 66 is electrically connected to the display assembly 30.

In some embodiments, the output circuit board 65 is configured to receive an output voltage from the first power circuit board 61 and convert the output voltage into at least one charging voltage, so as to provide the charging voltage to the corresponding to-be-charged device 2 through the interface assembly 40. The display circuit board 66 is electrically connected to the output circuit board 65 and configured for obtaining the charging information from the output circuit board 65, so that the charging information is displayed.

In some embodiments, the output circuit board 65 is disposed close to the interface assembly 40, and the display circuit board 66 is disposed close to the display assembly 30. Any two of the output circuit board 65, the display circuit board 66, and the first power circuit board 61 are configured to intersect with each other. Therefore, the accommodating space of the housing 10 is fully utilized, the charging device 1 is designed to be compact and portable, making it suitable for multiple scenarios such as home, office, or travel, thereby improving the user experience during charging. Moreover, any two of the output circuit board 65, the display circuit board 66, and the first power circuit board 61 are independent and combined with each other, which can improve reliability of the charging device 1. In addition, the output circuit board 65, the display circuit board 66, and the first power circuit board 61 are mutually independent, which facilitates maintenance and upgrading of the charging device 1, improving convenience.

In some embodiments of the present disclosure, the motherboard assembly 60 further includes a second power circuit board 62, an input circuit board 63, and a filter circuit board 64.

The second power circuit board 62 is configured to intersect with the output circuit board 65 and the first power circuit board 61, respectively. That is, the second power circuit board 62 is configured to intersect with the output circuit board 65, and the second power circuit board 62 is configured to intersect with the first power circuit board 61. In some embodiments, the second power circuit board 62 is disposed on the output circuit board 65 and the first power circuit board 61. A fourth angle is defined between the second power circuit board 62 and the output circuit board 65, that is, the second power circuit board 62 intersects with the output circuit board 65. A fifth angle is defined between the second power circuit board 62 and the first power circuit board 61, that is, the second power circuit board 62 intersects with the first power circuit board 61. The fourth angle and the fifth angle may be 90 degrees. The way in which the second power circuit board 62 is disposed on the output circuit board 65 and the first power circuit board 61 is the same as the way in which the output circuit board 65 is disposed on the first power circuit board 61, which may not be repeated here.

In some embodiments, the second power circuit board 62 is spaced apart from and parallel to the display circuit board 66. A width of the second power circuit board 62 is not greater than that of the display circuit board 66 or that of the output circuit board 65, so as to ensure that the second power circuit board 62 is located in a space defined by the display circuit board 66, the first power circuit board 61, and the output circuit board 65.

The filter circuit board 64 is spaced apart from the second power circuit board 62, and the filter circuit board 64 is located on a side of the second power circuit board 62 away from the display circuit board 66. In some embodiments, the filter circuit board 64 is disposed on the first power circuit board 61, the filter circuit board 64 is spaced apart from the second power circuit board 62, and the filter circuit board 64 is located on the side of the second power circuit board 62 away from the display circuit board 66. The way in which the filter circuit board 64 is disposed on the first power circuit board 61 is the same as the way in which the output circuit board 65 is disposed on the first power circuit board 61, which may not be repeated here.

In some embodiments, the filter circuit board 64 is disposed parallel to the second power circuit board 62, and a width of the filter circuit board 64 is not greater than that of the display circuit board 66 or that of the output circuit board 65, so as to ensure that the filter circuit board 64 is located in the space defined by the display circuit board 66, the first power circuit board 61, and the output circuit board 65.

The input circuit board 63 is disposed close to the plug assembly 20 and spaced apart from the first power circuit board 61. The input circuit board 63 is configured to intersect with the filter circuit board 64. In some embodiments, the input circuit board 63 is disposed on the filter circuit board 64, so that the input circuit board 63 intersects with the filter circuit board 64 and is spaced apart from the first power circuit board 61. The way in which the input circuit board 63 is disposed on the filter circuit board 64 is the same as the way in which the output circuit board 65 is disposed on the first power circuit board 61, which may not be repeated here.

In some embodiments, the input circuit board 63 is disposed parallel to the first power circuit board 61, and a distance between the input circuit board 63 and the first power circuit board 61 is not greater than the width of the display circuit board 66 or the width of the output circuit board 65, so as to ensure that the input circuit board 63 is located in the space defined by the display circuit board 66, the first power circuit board 61, and the output circuit board 65.

The second power circuit board 62 may be an advanced high-performance bus (AHB) power board that is configured to control AHB power of the charging device 1. The input circuit board 63 is configured to receive an input alternating current (AC) from the plug assembly 20 and to implement an electromagnetic interference (EMI) function. The EMI function may be implemented by using an EMI circuit in the related art, which may not be repeated here. The filter circuit board 64 is configured to implement a flexible printed circuit (FPC) filter function.

In some embodiments, the input circuit board 63 is electrically connected to the plug assembly 20 and the filter circuit board 64, respectively. The second power circuit board 62 is electrically connected to the first power circuit board 61.

In some embodiments, the input circuit board 63 is electrically connected to the socket by inserting the plug assembly 20 into the socket, so that the input circuit board 63 receives the input voltage from the external power source through the plug assembly 20. The filter circuit board 64 receives the input voltage from the input circuit board 63 and filters the input voltage. The first power circuit board 61 obtains the filtered input voltage from the filter circuit board 64, so as to provide the output voltage to the output circuit board 65.

In some embodiments, the filter circuit board 64 and the input circuit board 63 are stacked on the first power circuit board 61, so that the motherboard assembly 60 adopts a three-dimensional space design, fully utilizing the accommodating space of the housing 10, reducing a volume of the motherboard assembly 60, thereby reducing a volume of the charging device 1 and improving portability of the charging device 1.

In summary, the motherboard assembly 60 in some embodiments adopts the three-dimensional space design, fully utilizing the accommodating space of the housing 10, reducing the volume of the motherboard assembly 60, thereby reducing the volume of the charging device 1, improving the portability of the charging device 1, simplifying the assembly process of the charging device 1, and improving production efficiency.

In some embodiments of the present disclosure, as shown in FIGS. 2 and 5, the display assembly 30 includes a display screen 31 and a display lens 32, and the display lens 32 is disposed on the housing 10. The display lens 32 is installed on the housing 10 through the snap-fit method. The display lens 32 may include but is not limited to an acrylic lens, a plastic lens, etc.

The display screen 31 is disposed on a side of the display circuit board 66 away from the input circuit 63. The display screen 31 is configured to display the charging information. The display screen 31 faces the display lens 32, so that the user can obtain the charging information from the display screen 31 through the display lens 32.

In some embodiments, the housing 10 is provided with a window 111, and the window 111 is disposed away from the interface assembly 40. The display screen 31 is disposed corresponding to the window 111, so that the user can obtain the charging information from the display screen 31 through the display lens 32 and the window 111.

In some embodiments, the display assembly 30 further includes an operation assembly 33. The operation assembly 33 is disposed on a side of the display lens 32 close to the interface assembly 40, and configured for receiving an operation instruction to operate on the display screen 31.

In some embodiments, the operation assembly 33 may be a touch button below the display lens 32. When the user touches the touch button, the display circuit board 66 receives the operation instruction and operates on the interface of the display screen 31 based on the operation instruction. In some embodiments, the operation assembly 33 may be a mechanical button disposed on the display lens 32, which may not be repeated here.

The display assembly 30 in some embodiments further includes the operation assembly 33. The user interacts with the charging device 1 through the operation assembly 33, which further improve the user experience during charging.

In some embodiments of the present disclosure, the interface assembly 40 includes at least one interface 41 and a decorative member 42, and the at least one interface 41 is disposed on the output circuit board 65. In some embodiments, the interface assembly 40 includes one interface 41, and the interface 41 is disposed on the output circuit board 65. In some embodiments, the interface assembly 40 includes multiple interfaces 41, and the multiple interfaces 41 are spaced apart and disposed on the output circuit board 65.

In a case where the interface assembly 40 includes the multiple interfaces 41, all of the multiple interfaces 41 may be USB interfaces. The interface types of the multiple interfaces 41 may be the same or different. In this case, the charging information displayed on display screen 31 includes the charging power of each interface 41, the charging current of each interface 41, or the charging voltage of each interface 41, etc.

In some embodiments, the interface assembly 40 includes four interfaces 41, three of the four interfaces 41 have the same interface type, while the remaining one interface 41 of the four interfaces 41 has a different interface type from the three interfaces 41. The charging information displayed on the display screen 31 includes the charging power of the four interfaces 41.

In some embodiments, the interface assembly 40 includes at least one interface 41, that is, the interface assembly 40 includes one interface 41 or multiple interfaces 41, so as to form the charging device 1 with different interfaces 41. When the interface assembly 40 includes multiple interfaces 41, the charging device 1 may be configured to facilitate simultaneous charging of multiple to-be-charged devices 2, and the display screen 31 of the display assembly 30 can display the power corresponding to each interface 41, thereby improving efficiency and safety of the charging device 1.

In some embodiments, the decorative member 42 is disposed on the housing 10, and the decorative member 42 defines at least one through hole 421, so that the interface 41 is exposed through the corresponding through hole 421. In some embodiments, the decorative member 42 is fixed to the housing 10 through an adhesive technology, so that the decorative member 42 and the housing 10 are combined into a whole, improving the aesthetic appeal of the charging device 1.

In some embodiments of the present disclosure, as shown in FIG. 7, the charging device 1 further includes at least one cable 50. The at least one cable 50 is electrically connected to the interface assembly 40, respectively. The charging device 1 facilitates charging of the external to-be-charged device 2 connected to the interface assembly 40 through the cable 50. In some embodiments, the charging device 1 can facilitate simultaneous charging of multiple to-be-charged devices 2 connected to the interface assembly 40 through multiple cables 50.

In summary, the charging device 1 of the present disclosure includes the housing 10, the plug assembly 20, the display assembly 30, and the interface assembly 40. The housing 10 includes the first surface 11, the second surface 12, and the third surface 13. The first surface 11 and the second surface 12 are disposed opposite to each other, and the third surface 13 is adjacent to the first surface 11 and the second surface 12, respectively. The display assembly 30 is disposed on the first surface 11 and configured to display the charging information of the charging device 1. By disposing the display assembly 30 on the first surface 11 of the housing 10, the user can obtain the charging information through the display assembly 30, which can effectively alleviate the user's charging anxiety and improve the user experience during charging. Moreover, the plug assembly 20 of the present disclosure is disposed on the second surface 12. When the plug assembly 20 is inserted into the socket, the display assembly 30 faces a side away from the socket, and the display assembly 30 faces the user, so that the user conveniently views the display assembly 30 to obtain the charging information, thereby improving the user experience during charging. In addition, the interface assembly 40 of the present disclosure is disposed on the third surface 13 and configured to be connected to the to-be-charged device 2, so that the to-be-charged device 2 is charged. The interface assembly 40 is located between the plug assembly 20 and the display assembly 30, so that the cable 50 between the to-be-charged device 2 and the interface assembly 40 is properly routed or has reasonable wiring.

The effects of the present disclosure are as follows. The charging device of the present disclosure includes the housing, the plug assembly, the display assembly, and the interface assembly. The housing includes the first surface, the second surface, and the third surface. The first surface and the second surface are disposed opposite to each other, and the third surface is adjacent to the first surface and the second surface, respectively. The display assembly is disposed on the first surface and configured to display the charging information of the charging device. By disposing the display assembly on the first surface of the housing, the user can obtain the charging information through the display assembly, which can effectively alleviate the user's charging anxiety and improve the user experience during charging. Moreover, the plug assembly of the present disclosure is disposed on the second surface. When the plug assembly is inserted into the socket, the display assembly faces a side away from the socket. That is, when the plug assembly is inserted into the socket, the display assembly faces the user, so that the user conveniently views the display assembly to obtain the charging information, thereby improving the user experience during charging. In addition, the interface assembly of the present disclosure is disposed on the third surface and configured to be connected to the to-be-charged device, so that the to-be-charged device is charged. The interface assembly is located between the plug assembly and the display assembly, so that the cable between the to-be-charged device and the interface assembly is properly routed or has reasonable wiring.

The above descriptions are only some embodiments of the present disclosure, and are not intended to limit the protection scope of the present disclosure. Any equivalent structure or equivalent flow transformation made by using the contents and the accompanying drawings of the present disclosure, or directly or indirectly applied to other related technical fields, is included in the protection scope of the present disclosure.

1. A charging device, comprising:
a housing, comprising a first surface, a second surface, and a third surface, wherein the first surface and the second surface are disposed opposite to each other, and the third surface is adjacent to the first surface and the second surface, respectively;
a display assembly, disposed on the first surface and configured for displaying charging information of the charging device;
a plug assembly, disposed on the second surface and configured to be inserted into an external socket to receive external power input, wherein when the plug assembly is inserted into the socket, the display assembly faces a side away from the socket; and
an interface assembly, disposed on the third surface and configured to be connected to a to-be-charged device, so that the to-be-charged device is charged.

2. The charging device according to claim 1, wherein the plug assembly comprises plugs and a plug panel, the plugs are disposed on the plug panel; and when the plugs are inserted into the socket, the plug panel is in direct contact with the socket.

3. The charging device according to claim 2, wherein the charging device further comprises a motherboard assembly disposed in an accommodating space of the housing; and the motherboard assembly is connected to the plug assembly, the display assembly, and the interface assembly, respectively.

4. The charging device according to claim 3, wherein the motherboard assembly comprises:
an output circuit board, disposed close to the interface assembly;
a display circuit board, disposed close to the display assembly; and
a first power circuit board, disposed on a side of the housing;
wherein the output circuit board and the display circuit board are configured to intersect with the first power circuit board, respectively.

5. The charging device according to claim 4, wherein the output circuit board is electrically connected to the interface assembly, the display circuit board, and the first power circuit board, respectively; and the display circuit board is electrically connected to the display assembly.

6. The charging device according to claim 4, wherein the motherboard assembly further comprises:
a second power circuit board, configured to intersect with the output circuit board and the first power circuit board, respectively;
a filter circuit board, spaced apart from the second power circuit board and disposed on a side of the second power circuit board away from the display circuit board; and
an input circuit board, disposed close to the plug assembly and spaced apart from the first power circuit board, wherein the input circuit board is configured to intersect with the filter circuit board.

7. The charging device according to claim 6, wherein the input circuit board is electrically connected to the plug assembly and the filter circuit board, respectively; and the second power circuit board is electrically connected to the first power circuit board.

8. The charging device according to claim 4, wherein the display assembly comprises a display screen and a display lens, the display lens is disposed on the housing, and the display screen is disposed on a side of the display circuit board away from the input circuit board and configured for displaying the charging information.

9. The charging device according to claim 8, wherein the display assembly further comprises an operation assembly, the operation assembly is disposed on a side of the display lens close to the interface assembly, and the operation assembly is configured for receiving an operation instruction to operate on the display screen.

10. The charging device according to claim 4, wherein the interface assembly comprises at least one interface and a decorative member, the at least one interface is disposed on the output circuit board, the decorative member is disposed on the housing, and the decorative member defines at least one through hole, so that one of the at least one interface is exposed through a corresponding one of the at least one through hole.

11. The charging device according to claim 1, wherein the charging device further comprises at least one cable, the at least one cable is electrically connected to the interface assembly, and the charging device is configured to facilitate charging of the to-be-charged device connected to the interface assembly through the at least one cable.

12. A charging device, comprising:
a housing;
a display assembly, disposed on the housing and configured for displaying charging information of the charging device;
a plug assembly, disposed on the housing and opposite to the display assembly, wherein the plug assembly is configured to be inserted into an external socket; and
an interface assembly, disposed on the housing, wherein the interface assembly is disposed between the display assembly and the plug assembly, and the interface assembly is configured to be connected to a to-be-charged device.

13. The charging device according to claim 12, wherein the plug assembly comprises plugs and a plug panel, the plugs are disposed on the plug panel; and when the plugs are inserted into the socket, the plug panel is in direct contact with the socket.

14. The charging device according to claim 13, wherein the charging device further comprises a motherboard assembly disposed in an accommodating space of the housing; and the motherboard assembly is connected to the plug assembly, the display assembly, and the interface assembly, respectively.

15. The charging device according to claim 14, wherein the motherboard assembly comprises:
an output circuit board, disposed close to the interface assembly;
a display circuit board, disposed close to the display assembly; and
a first power circuit board, disposed on a side of the housing;
wherein the output circuit board and the display circuit board are configured to intersect with the first power circuit board, respectively.

16. The charging device according to claim 15, wherein the output circuit board is electrically connected to the interface assembly, the display circuit board, and the first power circuit board, respectively; and the display circuit board is electrically connected to the display assembly.

17. The charging device according to claim 15, wherein the motherboard assembly further comprises:
a second power circuit board, configured to intersect with the output circuit board and the first power circuit board, respectively;
a filter circuit board, spaced apart from the second power circuit board and disposed on a side of the second power circuit board away from the display circuit board; and
an input circuit board, disposed close to the plug assembly and spaced apart from the first power circuit board, wherein the input circuit board is configured to intersect with the filter circuit board.

18. The charging device according to claim 17, wherein the input circuit board is electrically connected to the plug assembly and the filter circuit board, respectively; and the second power circuit board is electrically connected to the first power circuit board.

19. The charging device according to claim 15, wherein the display assembly comprises a display screen and a display lens, the display lens is disposed on the housing, and the display screen is disposed on a side of the display circuit board away from the input circuit board and configured for displaying the charging information.

20. The charging device according to claim 19, wherein the display assembly further comprises an operation assembly, the operation assembly is disposed on a side of the display lens close to the interface assembly, and the operation assembly is configured for receiving an operation instruction to operate on the display screen.
